(19) United States
(12) Patent Application Publication
(10) Pub. No.: US 2004/0232641 A1
(43) Pub. Date: Nov. 25, 2004

(54) Thrust bushing for steering kingpin assembly

(76) Inventor: Terrence S. Kaiser, Millington, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/881,294

(22) Filed: Jun. 30, 2004

Related U.S. Application Data
(62) Division of application No. 10/219,860, filed on Aug. 15, 2002.
(60) Provisional application No. 60/312,545, filed on Aug. 15, 2001.

(51) Int. Cl. B62D 7/18

(52) U.S. Cl. 280/93.512

(57) ABSTRACT

The present invention relates to a thrust bushing formed in such a way as to maximize its lubrication during use to minimize its wear. Broadly, at least one surface of the bushing is formed with grooves that extend between its central aperture and its outer diameter to allow the free flow of lubricant between the two and thus lubricate the entire bushing surface of the thrust bushing as it rotates during steering. The grooves may take a variety of forms such as radially extending rectangular grooves or spiral grooves to better spread lubricant over the entire bushing surface. The bushings may be imposed directly between the axle and the lower yoke or may be packaged in a cartridge between a pair of discs to provide a self-contained, well-lubricated package.

### CROSS REFERENCES TO RELATED APPLICATIONS

This application is a divisional of U.S. application Ser. No. 10/219,860 filed Aug. 15, 2002, which claims priority of Provisional Application Ser. No. 60/312,545, filed Aug. 15, 2001.

### FIELD OF THE INVENTION

The present invention relates to improved bearing assemblies, in particular to a motor vehicle steering kingpin assembly having a lubricated thrust bushing disposed between the vehicle axle and the lower knuckle yoke member and, more particularly, to such a thrust bushing having grooves formed in one of its surfaces to allow the passage of lubricant between the central aperture in the bushing and its outer diameter.

### BACKGROUND OF THE INVENTION

The prior art, including U.S. Pat. No. 4,690,418 to Smith, assigned to the assignee of the present application, discloses a steering knuckle and kingpin assembly for a motor vehicle steering system. While the invention of the Smith patent resides in the specific frustoconical shape of a kingpin end, the present invention relates to such assemblies of a more general type. The assembly includes a disk-shaped thrust bushing with a central aperture for receiving the kingpin. The opposed surfaces of the thrust bushing are sandwiched between the lower surface of the front axle beam and the upper side of the lower yoke and the bushing (or bearing) disposed in the lower yoke bore to receive the lower end of the kingpin.

In that position, a substantial portion of the vehicle weight is imposed axially on the bushing and the bushing must also accept radial forces as a result of the rotation of the wheel about the kingpin. Due to these heavy axial loads and frequent rotation, these bushings often wear to the extent that they must be replaced. Because of the construction of steerable axle assemblies, the replacement of these bushings is a difficult, time-consuming process.

Hence, it is advantageous to prolong the lifetime on the bushing, for example through improved lubrication.

In U.S. Pat. No. 4,514,098, Ippolito describes a cylindrical bearing member formed of a coil spring. Cylindrical structures are not suitable for applications where a substantially disk shaped bearing is required. Other prior art also describes cylindrical structures. For example, in U.S. Pat. No. 4,257,654, Keepers describes a filament wound bearing having a cylindrical form.

In U.S. Pat. No. 4,569,601, Ippolito describes a wound wire bearing comprising a spiral spring. Due to the lack of tapering of the ends of the spring, both the outside perimeter and inside perimeters have a variable diameter, with a discontinuities corresponding to the ends of the spring coil. This is disadvantageous for applications where the outside perimeter or inside perimeter are required to be circular, for example if a close fit with other circular structures is required.

In U.S. Pat. No. 3,663,074, Fernlund et al. describe a spiral groove bearing. The grooves do not circumscribe the center (i.e., do not perform a complete revolution around the center), and there is no central aperture. Hence this configuration is not well suited for channeling lubricant, as the grooves do not extend from a central aperture to an outer perimeter.

### BRIEF DESCRIPTION OF THE INVENTION

The present invention therefore relates to a thrust bushing formed in such a way as to maximize its lubrication during use to minimize its wear. Broadly, at least one surface of the bushing is formed with grooves that extend between its central aperture and its outer diameter to allow the free flow of lubricant between the two and thus lubricate the entire bushing surface of the thrust bushing as it rotates during steering. The grooves may take a variety of forms such as radially extending rectangular grooves or spiral grooves to better spread lubricant over the entire bushing surface. The bushings may be imposed directly between the axle and the lower yoke or may be packaged in a cartridge between a pair of discs to provide a self-contained, well-lubricated package.

Several embodiments of the invention are disclosed in the following detailed description. The description makes reference to the accompanying drawings in which:

### BRIEF DESCRIPTION OF THE DRAWINGS

FIG. 1 is a schematic illustration of a steering knuckle and kingpin assembly provided with a bushing formed in accordance with the present invention;

FIG. 2 is an exploded perspective drawing of a cartridge type bushing having radial grooves in both of the opposed bushing surfaces;

FIG. 3 is a cross-sectional view through the bushing of FIG. 2;

FIG. 4 is a perspective view of an alternative embodiment of the bushing having a spiral groove formed in one of its surfaces between its interior diameter and its outer diameter; and

FIG. 5 is a view of an alternative form of bushing wherein the spiral bushing is formed by winding a steel rod into a spiral.

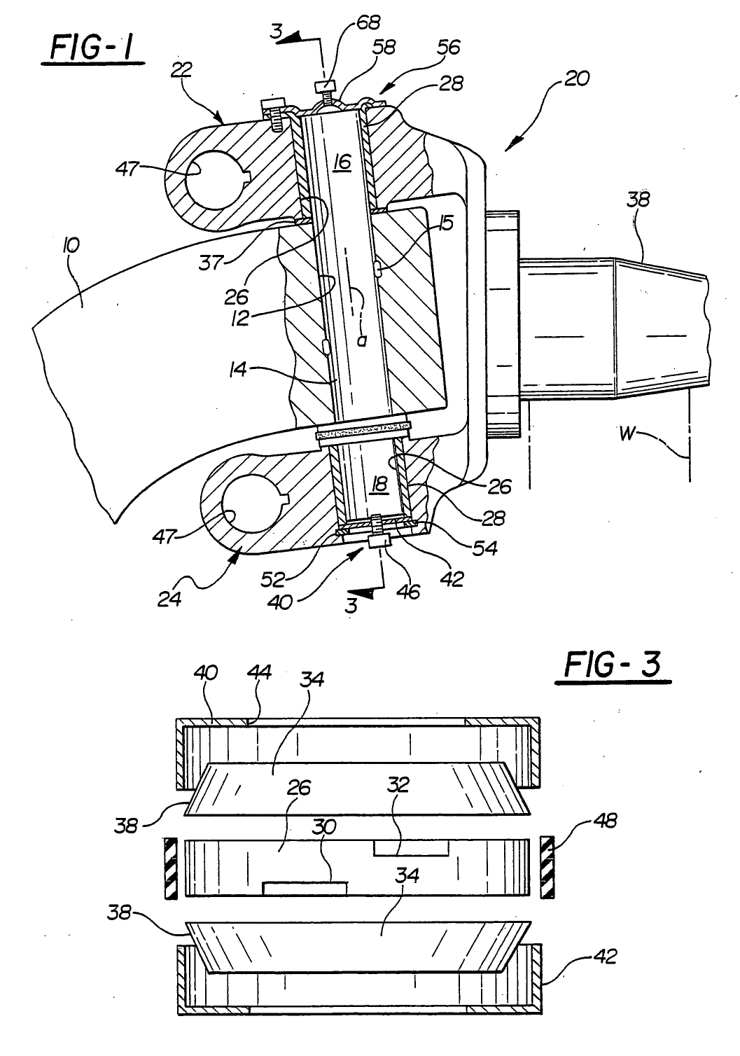

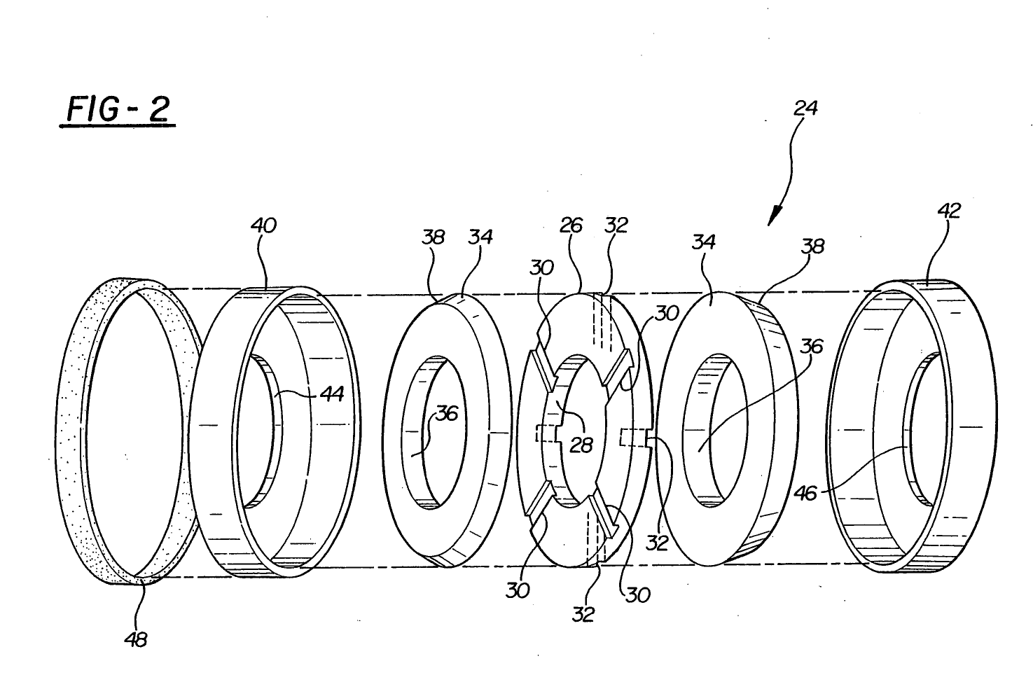

### DETAILED DESCRIPTION OF THE PREFERRED EMBODIMENTS

FIG. 1 illustrates a steering knuckle and kingpin assembly, generally indicated at 10, comprising a kingpin 12 affixed through a bore in one end of a rigid front axle beam 14. A wheel spindle knuckle 16 is pivotably mounted relative to the kingpin 12 by way of two integral upper and lower yoke members 18 and 20. A wheel spindle 22 is fixed to the knuckle 24.

As heretofore described, the assembly is generally of the type shown in U.S. Pat. No. 4,690,418 to Smith, incorporated herein by reference, assigned to the assignee of the present invention. The novelty resides in the provision of a lubricated bushing, generally indicated at 24, which surrounds the kingpin 12 in a sandwich between the lower surface of the axle beam 14 and the upper surface of the lower yoke 20. In the Smith patent referred to, the bushing took the form of a disk with a central aperture. However, the axial forces imposed on the bushing, and the rotational forces imposed on the bushing 24 during steering can create considerable wear requiring replacement of the bushing. By providing a lubricated bushing as disclosed hereinafter, wear is minimized.

An exploded view of the lubricating bushing cartridge 24 is illustrated in FIG. 2. The central bushing element 26 constitutes a circular disk of hardened steel with a central circular aperture 28. A plurality of shallow grooves 30 are formed radially in each surface of the bushing, extending between the central aperture 28 and the outer perimeter of the disc. The grooves 30 are arrayed at 90° angles to each other in the preferred embodiment and the grooves on the opposite side of the disk 32 have an angular displacement of approximately 45° from each of the grooves 30. In other embodiments, the angular displacement between similar groove patterns on opposed surfaces of the bushing may be approximately equivalent to half the groove width at the outer perimeter, the groove width at the outer perimeter, or up to 45°. In other embodiments, different groove patterns may be formed on each surface, e.g. a spiral groove on one surface and radial grooves (or no grooves) on the other surface. The bushing 26 is sandwiched between a pair of circular discs 34 having central apertures 36 of the same diameter as the aperture 28 and the bushing 26. The discs 34 preferably have downwardly tapered outer surfaces 38. The sandwich consisting of the bushing 26 and the two discs 34 is contained within a two-part sheet steel casing consisting of dish-shaped members 40 and 42 having central apertures 44 and 46 respectively of the same diameter as the apertures 28 and 36. An outer resilient band 48 extends over the outer diameters of the two casing shells 40 and 42 to retain them in a closed assembly.

The grooves function to allow the circulation of oil between the kingpin and the bushing surfaces. The lubrication may come from normal kingpin lubrication or lubrication provided within the bushing casing.

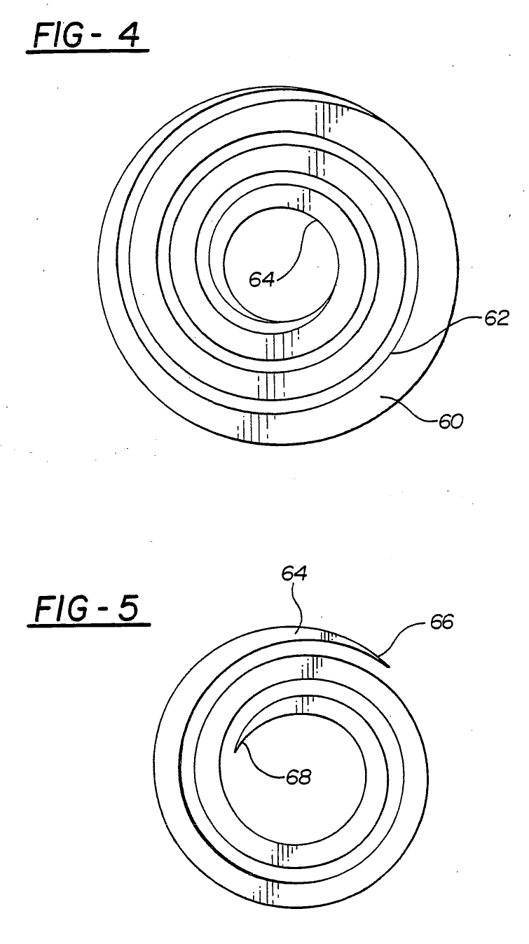

The grooves that lubricate the bushing may have other configurations. FIG. 4 illustrates a bushing 60 having a spiral groove 62 formed in its surface between a central aperture 64 and the outer perimeter of the disc. The grooves may be formed on one or both sides of the bushing.

The grooves may have a uniform groove width, or the groove width may be a function of distance from the central aperture and/or angle to the local radius, for example so as to promote uniform flow through the groove.

One or more spiral grooves may be provided on a surface of the bushing, for example a plurality of spiral grooves having an angular displacement from each other.

It can be advantageous for a spiral groove to circumscribe the central aperture at least once, at least twice, at least three times, or at least some greater number of circumscriptions, for example so as to reduce the outflow of lubricant from the central aperture while providing adequate lubricant supply to local frictional hot spots.

FIG. 5 illustrates an embodiment of the invention where the bushing itself is formed of a spiral wound strip 64 of spring steel with tapered ends 66 and 68. Again, the space between the coils of the bushing thus formed facilitates the lubrication of the frictional surfaces.

The grooved bushing discs may be directly disposed between the axle and the lower yoke, alternatively to being supported in a cartridge.

Hence, an improved bushing for a bearing assembly comprises an apertured disk, having a circular outer perimeter and a circular central aperture defined by an inner perimeter, the outer and inner perimeters preferably being concentric, the bushing having a first surface and a second surface. The surfaces are preferably flat and parallel, and are spaced apart by a constant thickness of the bushing. In other embodiments, one or both surfaces may be convex, concave, beveled, or otherwise curved or shaped, so that the bushing thickness may vary, or may be constant within a curved plane. The apertured disk has an inner diameter (the diameter of the inner perimeter and the central aperture), and an outer diameter (the diameter of the outer perimeter). A spiral groove can be formed in the disk, extending in a spiral path from the central aperture to the outer perimeter. (An apertured disk can also be formed by coiling a strip, such as a wire, as is discussed in more detail elsewhere). The spiral groove may extend partially through the thickness of the disk, or may extend completely through the thickness of the disk so as to be equivalent to a spiral cut. In this case, the edges of the sides of the resulting spiral cut can be straight (either parallel or not parallel), curved, bowed, beveled, or otherwise shaped. The spiral groove may be formed in an anticlockwise or clockwise direction. The cross section of the groove may be square, rectangular, semicircular, triangular, polygonoid, rounded, beveled, or otherwise shaped. The groove may be in fluid communication with a source of lubricant, such as a central axle or other lubricated structure.

Machining methods for forming the groove include mechanical methods (such as sawing, cutting), lithography, and laser cutting. The groove may be formed by a stamping process, which may also be used to produce an apertured disk.

The bushing may have a uniform composition, for example comprising spring steel, hardened steel, or other steel. Alternatively, the bushing may have a multilayer structure, for example comprising a hardened steel disk coated on one or both sides with a softer metal.

For a groove extending through the thickness of the bushing, the groove may have appreciable width, so that adjacent coils of the resulting spiral structure are not abutting, or have insignificant width so that the adjacent coils of the resulting structure are substantially abutting.

Bushings according to the present invention may comprise: metal (such as steel (e.g. spring steel or hardened steel), iron, bronze, aluminum alloy, tin alloy, nickel alloy, Babbitt metal, or other alloy); polymer (such as fiber-reinforced plastic, thermoplastic such as polyetheretherketone); ceramic; glass ceramic; carbide-containing material; or other suitable material or combination of materials. Materials may be combined so as to create a uniform or non-uniform (e.g. multilayer) composition. Bushings may further comprise: antigalling agents (such as silver); lubricants (such as surface coatings, infused lubricants, oils, solid lubricants (e.g. molybdenum disulfide)); anti-seizure components; and other advantageous materials.

A bushing according to the present invention can be formed by coiling a strip, wire, or other elongated structure. For convenience, in this specification, the term strip will be used to include wires and other elongated forms. Preferably, the two ends of the strip are tapered, so as to provide an apertured disk having a circular inner perimeter having an inner diameter, and a circular outer perimeter having an outer diameter. If the ends of the strip were not tapered, the perimeters of the bushing would not be circular due to the discontinuous change in local diameter at the ends of the strip. Tapering advantageously allows a circular perimeter having a single diameter. (Where a space between coils of the strip meets a perimeter, the local perimeter of the bushing can be defined by an extension of the circular perimeter of the surrounding material.)

The space between the coils of the bushing provides a channel for effective distribution of lubricant, and a space for metal debris or other contaminant particles or fluids to accumulate without damaging the bushing. As illustrated in FIG. 5, the sidewalls of adjacent turns may not be in abutting engagement, advantageously providing a broad lubricant channel for lubricants and contaminants suspended therein. Lubricant may be added, removed, or exchanged by providing fluid communication with a source or sink of fluid lubricant.

A similar bushing can be provided by forming a spiral groove in an apertured circular disk, where the spiral groove extends through the thickness of the apertured disk, so as to be equivalent to a spiral cut, and the spiral groove has appreciable width so that adjacent coils are not in abutting engagement.

A space between the coils of the bushing may be provided by coiling a strip using a mechanical guide. Alternatively, a coating layer may be provided on a strip which is removed after coiling the strip into a spiral form, the removal process providing a space between adjacent coils.

In other embodiments, the space between coils of the bushing, or grooves, can be advantageously filled with one or more additional solid components. For example, the additional solid components may comprise a solid lubricant, a softer metal component, an antigalling agent, or other advantageous component. For example the inter-coil spaces of a hardened steel bushing may be filled, in part or in whole, with a softer metal or solid lubricant. Local heating of the bushing, due to friction, can expand or liquefy a lubricant so as to provide extra local lubrication.

The coils of the bushing may have a uniform composition, or, in other embodiments, may comprise a number of components. For example, a bushing may be formed from a coiled strip comprising a multilayer structure. A bushing may be formed from a coiled wire having a central steel core with a surrounding layer formed from another metal. A coiled strip may have a sandwich structure of different metal components. A bushing in which a spiral groove is formed may have a multilayer structure, such as a sandwich structure, of different components.

A coiled strip may comprise a wire in the form of a cable formed from a plurality of individual filaments, for example in a rope-like structure. The filaments may all be of the same composition, or a cable may be formed from filaments of different composition. For example, a cable may comprise a number of steel filaments and also one or more filaments comprising, for example, an antigalling agent, a lubricant, a softer metal, or some other advantageously included material.

A bushing according to the present invention may be also be formed by molding. For example, a metal or non-metal can be molded into a bushing according to the present invention. A bushing according to the present invention can be also be formed by sintering, for example using powder metallurgy. For example, metal or ceramic particles can be formed into a bushing form generally according to the present invention, followed by a heating and/or compression processes.

Bushings according to the present invention may be porous, and may further be infused with one or more lubricants.

After forming a bushing according to an embodiment of the present invention, the bushing may be subjected to heat treatments (such as hardening or softening), coated with one or more lubricants, infused with e.g. carbon, otherwise treated so as to modify its mechanical properties, treated so as to smooth, round, or bevel perimeters and/or edges, or be otherwise treated. For example, abutting coils of wire or adjacent cable filaments within a coiled cable may be fused together. A cable or other porous structure may be infused with another material, for example by a liquid infusion (for example by a liquid metal) or by a vapor infusion processes.

The ends of a strip used to form the bushing can be tapered before or after a coiling process, so as to provide a bushing in the form of an apertured disk having a spiral groove extending from a central circular aperture to a circular outside perimeter. Alternatively, a coiled strip having tapered ends may result from forming a spiral groove through the thickness of an apertured disk.

A bushing may be also be formed from a plurality of strips coiled together, with the ends of each strip advantageously tapered so as to provide circular perimeters. For example, coiled strips may adjoin axially, radially, or both. A plurality of strips may be coiled so as to form a bushing comprising a spiral strip interposed with one or more other spiral strips. After coiling, the bushing may be heated so as to fuse, interdiffuse, or vaporize components.

In other embodiments, a bushing according to the present invention may be provided without a central aperture, for example formed by a coil having a single tapered end so as to provide a circular outer perimeter. In other embodiments, either the outer or inner perimeter need be circular.

For illustration purposes only, for use in an automotive steering assembly, a bushing may have an outer perimeter diameter of between 2 and 2.5 inches, a central aperture diameter of between 1 and 1.5 inches, and a spiral groove having a groove width of between 0.05 and 0.5 inches, for example in the range 0.1 to 0.2 inches.

Other embodiments of the invention will be clear to those skilled in the art. The examples discussed are not intended to be limiting. Bushings according to the present invention may be used in steering assemblies, drill assemblies, other thrust bearing assemblies or other applications as will be clear to those skilled in the art.

Having thus disclosed my invention,

I claim:

1. A steering knuckle and kingpin assembly for a motor vehicle steering system having a bushing disposed between the lower surface of the vehicle axis and the upper surface of the lower knuckle yoke, the bushing being disk shaped with opposed bushing surfaces, a central aperture, and an outer perimeter, the central aperture surrounding the kingpin, the bushing having a groove formed on at least one of its bushing surfaces operative to distribute lubricant.

2. The assembly of claim 1 wherein the groove extends between the central aperture and the outer perimeter of the bushing.

3. The assembly of claim 1 wherein a groove is formed on each of the bushing surfaces, both grooves extending between the central aperture and the outer perimeter of the bushing.

4. The assembly of claim 1 wherein the groove is spiral in form extending between the central aperture of the bushing and the outer perimeter of the bushing.

5. The assembly of claim 4, wherein the groove circumscribes the central aperture at least once.

6. The assembly of claim 1, wherein the bushing is formed of a spiraled strip, whereby lubricant can pass between adjacent coils of the spiral strip.

7. The assembly of claim 6, wherein the strip has tapered ends so as to provide a circular outer perimeter and a circular central aperture.

8. The assembly of claim 1, wherein the bushing is sandwiched between two apertured disks.

9. The bushing of claim 1, wherein both bushing surfaces are formed with a plurality of radial grooves.

10. The bushing of claim 9, wherein each bushing surface has four radial grooves, the radial grooves having an angular separation from each other of approximately 90°.

11. The bushing of claim 9, wherein one bushing surface has a first groove pattern which has an angular displacement from a similar second groove pattern formed on the other bushing surface.

12. The bushing of claim 11, wherein the angular displacement is approximately 45°.

13. A steering knuckle and kingpin assembly comprising:
a kingpin affixed through a bore in one end of a rigid front axle beam;
a wheel spindle knuckle pivotably mounted relative to the kingpin by way of two integral upper and lower yoke members;
a wheel spindle fixed to the knuckle;
a bushing surrounding the kingpin, located between the axle beam and the lower yoke,
wherein the bushing comprises a disk having a central aperture, a circular outer perimeter, a pair of parallel surfaces and a spiral groove formed in one of said surfaces extending from the central aperture to the outer perimeter.

14. The assembly of claim 13 wherein the spiral groove has a uniform width along its length.

15. The assembly of claim 13 wherein the spiral groove circumscribes the central aperture at least once.

16. The assembly of claim 13, wherein the bushing is sandwiched between two apertured disks.

17. The assembly of claim 16, wherein the spiral groove extends through the disk thickness so as to be equivalent to a spiral cut.

18. The assembly of claim 17, wherein the space between adjacent coils of the bushing has a width of at least 0.05 inches, so that adjacent coils are not in abutment.
